(19) United States
(12) Patent Application Publication
(10) Pub. No.: US 2008/0307233 A1
(43) Pub. Date: Dec. 11, 2008

(54) Encoded Data Security Mechanism

(75) Inventor: Matthew Alexander Calman, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/760,750

(22) Filed: Jun. 9, 2007

(51) Int. Cl. H04L 9/00

(52) U.S. Cl. 713/179

(57) ABSTRACT

A method and system for securing and tracing confidential data is described. A request to generate a hardcopy printout is received by a computing device. Document output instructions for the request then are generated and data to associate with the document output instructions is determined. Then the determined data is encoded with the generated document output instructions. The encoded data includes information specific to a terminal device associated with the request and an identifier representative of a starting position for reading the encoded data. One ore more software modules within a terminal device, an intermediate server, and/or a printer may perform the operation of encoding the data. A hardcopy printout includes the content requested to be printed in addition to the encoded data. The encoded data may appear as representations of noise on one or more pages of the hardcopy printout.

### BACKGROUND

Identity theft, whether specific to a customer or to a corporate entity, is a problem that has drastically ramped up with the advent of the digital age. The effect on individuals and entities can be severe. In turn, the need to protect an identity has become much more important.

As industries, such as the financial banking industries, have increased their frequency in handling corporate and customer confidential information, the need to secure that confidential information throughout its use has increased as well. When utilizing such information, in any manner, strict adherence to security protocols is important in order to ensure that individuals and entities are not harmed by its use as well as to ensure that institutions maintaining such information take every means possible to prevent nefarious use.

Customer confidential information, whether for a company or an individual, is important in maintaining that customer for future business. In addition, such confidential information is necessary in order to ensure that an entity utilizing that customer is protected from risk associated with that customer. For example, when obtaining a loan on a home, a potential buyer, in securing her financial loan, may have to provide specific confidential information, such as a social security number, a listing of outstanding debts, and/or civil or criminal suits against the potential buyer, to a financial backing entity, such as a bank. The bank utilizes this information, in addition to other information, to determine whether to proceed with a line of credit, e.g., a loan, to the potential buyer. Such confidential information maintained at the bank may be stolen and used to fraud another and ultimately harm the potential buyer's credit record.

One problem faced by a company that maintains confidential information is protection from individuals within the company that may want to profit from the confidential information. Even more difficult is such an individual within the company that is allowed to access and work with confidential information as part of her job. This individual is in a trusted position in which dissemination of confidential information is eased due to her position. For example, when working with such confidential information, an individual can print a screen shot of the contents of a display. The printout of the screen shot may then be used or sold to others to allow someone to profit from the stolen confidential information.

A problem exists in that even if the actual printout of the screen shot is recovered, there may be no way to determine who printed the screen shot. Therefore, a nefarious individual within the company may still be able to continue to steal such confidential information.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to at least one aspect of the present invention, a method for securing and tracing confidential information is described. When a user initiates a print job request, document output instructions for the request are generated. Particular data is then determined to associate with the document output instructions. Such data may include user specific information, such as a name or operator number, document specific information, such as an indicia as to what type of content is being printed, and/or session specific data, such as the time and date of the request or a terminal device number from which the request came. The data is then encoded with the generated document output instructions. This encoded data and output document instructions may then be sent to a printer driver where a hardcopy printout is generated of the desire content and the encoded data. The encoded data includes information specific to a terminal device associated with the request to print. The encoded data may appear as at least three representations of noise on the hardcopy printout and include an identifier representative of a starting position for reading the encoded data.

According to another aspect of the present invention, different components, such as a printer, a terminal device, such as a user's computer, and/or a server may be configured with one or more software modules to encode data associated with a print request with the content to be printed. Still another aspect of the present invention includes a network system of computers, servers, and printers, where data is encoded with hardcopy printouts.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present invention and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present invention may be implemented;

FIG. 2 is a flow chart of an illustrative method for encoding a hardcopy printout in accordance with at least one aspect of the present invention;

FIGS. 3A and 3B are illustrative diagrams of communications between computer-related devices in accordance with at least one aspect of the present invention;

FIGS. 4A-4C are illustrative examples of encoded hardcopy printouts in accordance with at least one aspect of the present invention;

FIG. 5 is a flow chart of an illustrative method for reading hardcopy printouts in accordance with at least one aspect of the present invention;

FIG. 6 is an illustrative diagram of communications between computer-related devices in accordance with at least one aspect of the present invention; and

FIG. 7 is an illustrative diagram of a comparison between a hardcopy printout and a read hard copy printout in accordance with at least one aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

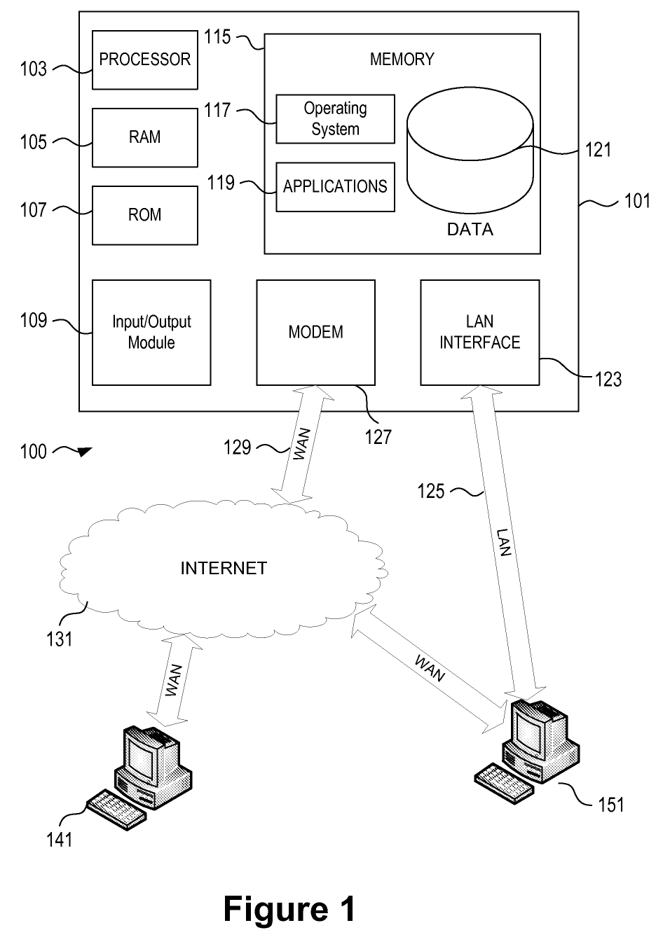

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media can be any available media that can be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like. As described herein, input/output module 109 may also include a reader/scanner to read/scan deposit items, including monetary items, to identify the type of monetary item it is. Such readers/scanner may read magnetic ink character recognition (MICR) data and/or other data from the monetary items for identification of the type of monetary item.

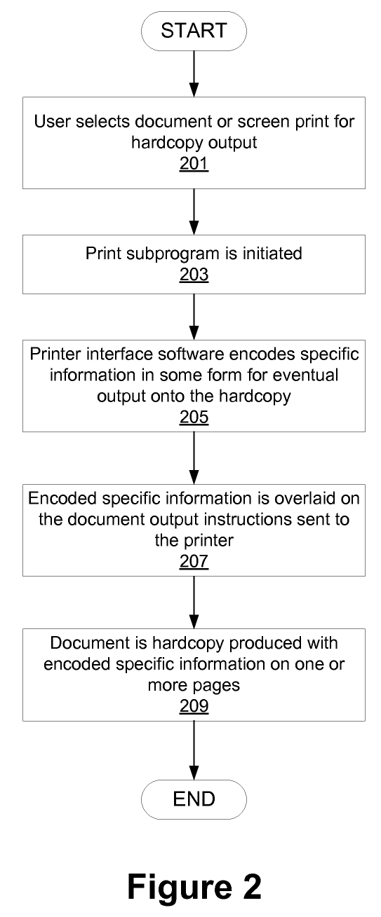

FIG. 2 is a flow chart of an illustrative method for encoding a hardcopy printout in accordance with at least one aspect of the present invention. The process starts and at step 201, a user selects a document or screen print function to initiate generation of a hardcopy printout. As should be understood by those skilled in the art, although described in the following examples as a printout in the form of physical paper, a print request to print as a PDF file may also be utilized in accordance with one ore more aspects of the present invention.

At step 203, a print subprogram associated with the terminal device of the user is initiated. Printer interface software encodes specific information in some form for eventual output onto the hardcopy printout at step 205. The form for the encoded specific information may take any of a number of different forms. For example, an indicium, such as a graphical glyph may be utilized to maintain the encoded data. The glyph may be a logo of an entity, a general header, or some other indicia. In another example, white noise may appear on the hardcopy printout as described in further detail below. In still another example, combinations of glyphs and noise may be utilized as explained more fully below.

Such specific information may include, but is not limited to, user specific data, session specific data, and/or document specific data. User specific data may include a name of the user associated with a user profile being run on the requesting terminal device. In other examples, user specific data may include a code number associated with the user of the terminal device, a password associated with the user of the terminal device, and/or an operator title or other type of user specific data.

Session specific data may include data regarding the session itself. For example, session specific data may include the date and/or time when a print request was initiated. It may include data on a server that processed the request, or the terminal device that sent the request, or the type of content file, such as a screen shot of a display of the terminal device compared to a word processing program, a place where the hardcopy was printed, a department location for the printout, and/or other types of session specific data. In addition, data may include information regarding other application programs that were open, i.e., active, on the operating system of terminal device that requested the hardcopy printout. Such information may be helpful in identifying if someone is attempting to “cut and paste” highly confidential information from one program to another before printing.

Document specific data may include any type of data associated with the document to be printed. For example, document specific data may include information regarding the author of the document being requested to print, the application program associated with the content of the hardcopy printout request, and/or a sensitivity code associated with the document file that identifies a level of confidentiality associated with the document. For example, a document file may include customer social security numbers. Such information may be deemed highly confidential and, as such, may ensure that the document has a sensitivity code of very highest for it. As such, if such a document file were ever printed, in accordance with one or more aspects of the present invention, encoded data may be included with the hardcopy printout indicating that the content of the hardcopy printout is of a highly sensitive nature due to confidential information being included.

Returning to FIG. 2, as part of the process of step 205, the specific information to associate with the document output instructions may be determined. For example, procedures may be configured to identify the user associated with the request for the hardcopy printout. A determination may be made to ascertain whether that person is authorized to print a hardcopy without the need to include encoded data at all. Alternatively, in another example a determination may be made as to what data to encode for that particular person. A new employee may have more specific data encoded than a veteran of the company may. These and other types of determinations may be made to ensure that desired and/or proper data is encoded.

The process proceeds to step 207 where the encoded specific information from step 205 is overlaid on the document output instructions sent to a printer. The encoded specific information may be sent separate from the document output instructions or may be sent with them. In addition, the encoded specific information, e.g., data, may be processed with the document output instructions to be integrated within the document or instructions or may be included separate from, but at the same time as the document output instructions. Before the process ends, at step 209, a hardcopy printout is generated to include the content desired to be printed in addition to the encoded specific information. The encoded data within the hardcopy printout includes the information specific to the terminal device associated with the request. Whether that information is user specific, document specific, and/or session specific, the encoded information is specific to the terminal device associated with the request. It should be understood by those skilled in the art that any of a number of methods may be utilized to encode data onto a hardcopy printout and that the present invention is not so limited to any particular method, even if illustrated herein.

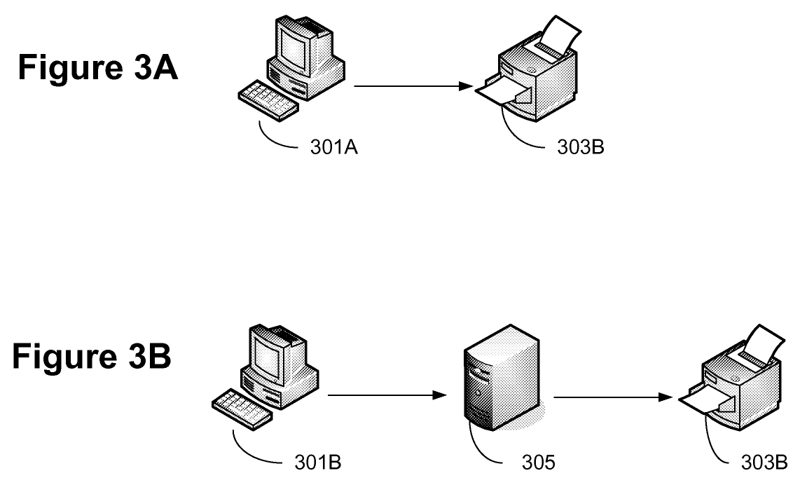

FIGS. 3A and 3B are illustrative diagrams of communications between computer-related devices in accordance with at least one aspect of the present invention. As shown in FIG. 3A, a terminal device 301A, e.g., computer, sends a request for a hardcopy printout directly to a printer 303A. As shown in FIG. 3B, a terminal device 301B, e.g., computer, sends a request for a hardcopy printout to a printer 303B. However, the request is sent through a server 305. With respect to each of these components 301, 303, and 305, one or more software modules resident on one or more of the components may be configured to perform one or more of the operations of receiving requests, generating document output instructions, determining specific information to associate, and encoding the data with the instructions. A printer driver, residing on a terminal device, server, printer, or intermediary computing device, may be configured to ensure that any or all hardcopy printouts include encoded specific information for securing and being able to trace the hardcopy printouts. Any of the components 301, 303, and/or 305 may be configured to keep an addition logging of hardcopy printouts that are made.

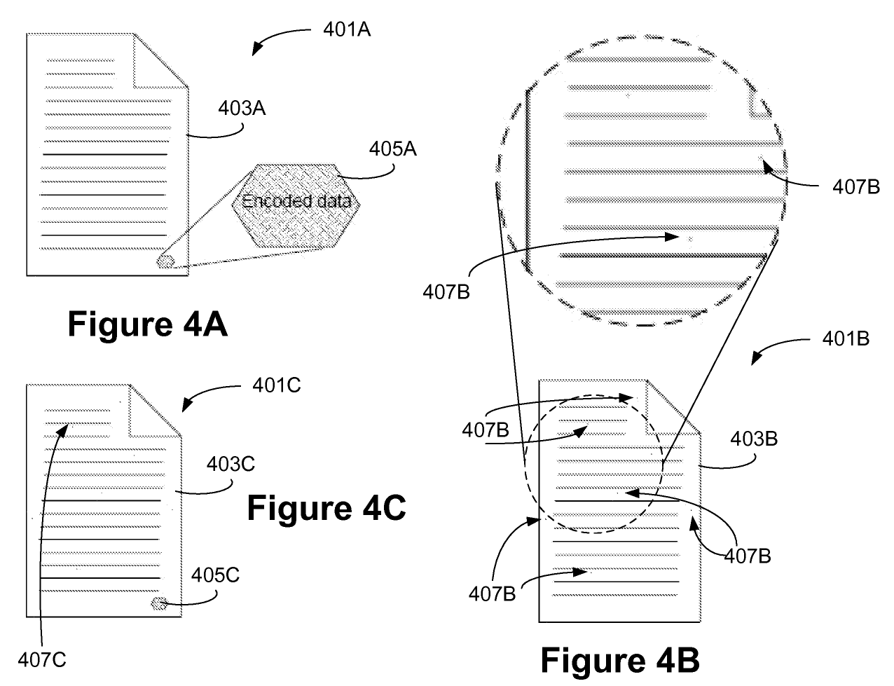

FIGS. 4A-4C are illustrative examples of encoded hardcopy printouts in accordance with at least one aspect of the present invention. FIG. 4A illustrates an example hardcopy printout 401A. Hardcopy printout 401A includes a printout of the content 403A that a user of a terminal device desired to be printed. Hardcopy printout 401A also includes encoded data 405A. In this example, encoded data 405A is shown as a glyph in the lower right hand corner of the document page of the hardcopy printout 401A. One or more of encoded data glyph 405A may be included on the hardcopy printout 401A and one is merely shown for illustrative purposes. Encoded data glyph 405A may appear as many different forms, including a logo of an entity associated with the terminal device and/or printing device, and/or content 403A to be printed. Such an encoded data glyph 405A may be configured to maintain 20 KB or more of data, which is an ample amount for encoding data associated with a terminal device. Encoded data glyph 405A may be generated by microprint. In addition, encoded data may be in a color, thus allowing even more data to be encoded in a hardcopy printout. In an illustrative example, the use of yellow ink may be utilized in the hardcopy printout for the encoded data. Yellow ink or a pale color is more difficult for the human eye to see, thus the encoded data would appear more as noise to a human. As such, it should be understood by those skilled in the art that any type of print, such as microprint, and/or black or colored ink may be utilized in creation of encoded data in a hardcopy printout in accordance with one or more aspects of the present invention.

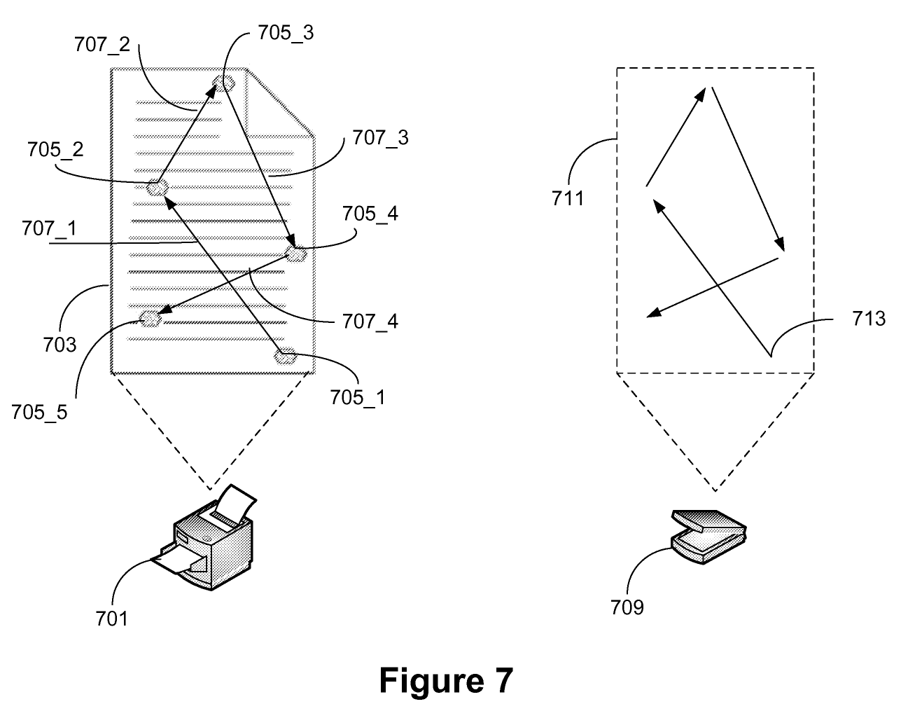

FIG. 4B illustrates an example hardcopy printout 401B. Hardcopy printout 401B includes a printout of the content 403B that a user of a terminal device desired to be printed. Hardcopy printout 401B also includes encoded data 407B. In this example, encoded data 407B is shown as various pixels or clusters of pixels that would appear as nothing more than noise to an observer's eye. Although not shown in the Figures, it should be understood by those skilled in the art that the use of punctuation marks and/or bullets or other typographical markings may be utilized as data carriers. In particular, the boundaries of these types of markings may be utilized. Such boundaries may be recognizable as an anchor. The encoded data noise 407B may be randomly dispersed on one or more pages of the hardcopy printout 401B or may be located in one particular location on one or more pages. In addition, encoded data noise 407B may be configured to be included on a hardcopy printout 401B is a particular pattern but appearing to the human eye as being randomly dispersed. Such an illustrative example is described below with respect to FIG. 7. Such random dispersion may vary over time to maintain the appearance of random noise, while adhering to the use of multiple pre-set anchor points as seeds for the search illustrated in FIG. 7.

FIG. 4C illustrates an example hardcopy printout 401C. Hardcopy printout 401C includes a printout of the content 403C that a user of a terminal device desired to be printed. Hardcopy printout 401C also includes encoded data 405C and 407C. In this example, encoded data 405C is shown as a glyph in the lower right hand corner of the document page of the hardcopy printout 401C. One or more of encoded data glyph 405C may be included on the hardcopy printout 401C and one is merely shown for illustrative purposes. In addition, encoded data 407C is shown as various pixels or clusters of pixels that would appear as nothing more than noise to an observer's eye. As shown in hardcopy printout 401C, encoded data is included in both glyph form 405C and noise form 407C.

Hardcopy printout 401A-401C are designed to survive photocopying. As such, even if an individual makes a photocopy of the hardcopy printout, the encoded data remains in the document in order to ensure that the confidential information remains tagged or associated with the encoded data. A reader computing device, as described below, reads the encoded data and may read the encoded data from a photocopy of the original hardcopy printout even if photocopied many times.

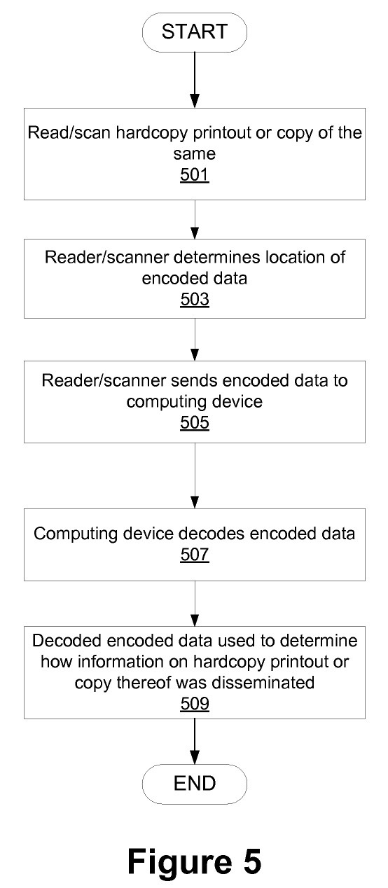

FIG. 5 is a flow chart of an illustrative method for reading hardcopy printouts in accordance with at least one aspect of the present invention. The process starts and at step 501 a hardcopy printout or copy thereof is read, e.g., scanned, to initiate the process to extract encoded data. Such encoded data may correspond to the illustrative examples shown in FIGS. 4A-4C. At step 503, an associated reader computing device, such as a preconfigured scanner type device, determines the location of the encoded data. As should be understood by those skilled in the art, the mechanism or tool for reading the encoded data may be software. As such, it should be understood that the associated reader computing device may include software in some form to perform the associated functions described herein.

As described herein with respect to FIG. 7, the associated reader computing device may be preconfigured with an indicator of a starting position to begin interpreting the encoded data from the printout. Alternatively, the associated reader computing device may be configured to search for and determine the location of the encoded data, whether as a starting position for reading other encoded data or for the encoded data itself. Furthermore, the starting location may be ascertained through algorithmic interpretation of the contents of the page to preserve relative locations in the event of scaling, such as enlargement or reduction, of the original. It should be understood by those skilled in the art that a variety of algorithms could be applied, following an approach where more critical data may be stored with a more survivable feature or indicia. Such an example may be in the case of a glyph-logo with richer data being stored in an area that is more obscure and more survivable, such as embedding microprint in the boundaries of shapes, lines, characters, or punctuation.

Proceeding to step 505, the associated reader computing device sends the encoded data to a computing device. The computing device may be a CPU within the associated reader computing device and/or may be a computing device external to the associated reader computing device. Whether with the associated reader computing device or external to it, the computing device decodes the encoded data at step 507. Then, as step 509, the decoded encoded data may be used to determine how the information on the hardcopy printout was disseminated. For example, in determining that the hardcopy printout was printed by a “John Smith,” Mr. Smith can then be spoken with to determine the circumstances of the hardcopy printout, such as the purpose or reason for printing. Should the dissemination of the hardcopy printout be for illegal or improper purposes, this step may be used by law enforcement officials or an entity to trace the originals of the hardcopy printout. As such, even if an individual sells, reproduces, or distributes, the hardcopy printout to another, the original person responsible for the printout may be determined to be questioned and/or held responsible. It should be understood by those skilled in the art that any of a number of methods may be utilized to decode encoded data form a hardcopy printout and that the present invention is not so limited to any particular method, even if illustrated herein.

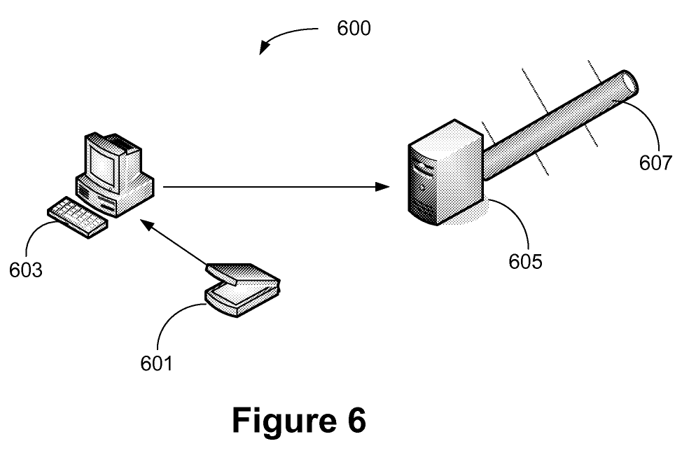

FIG. 6 is an illustrative diagram 600 of communications between computer-related devices in accordance with at least one aspect of the present invention. As shown in FIG. 6, an associated reader computing device 601, e.g., a scanner, is shown operatively connected to a computing device 603. Although illustrated in the present example as separate form the associated reader computing device 601, the computing device 603 may be included with the associated reader computing device as well. As shown, data read by the associated reader computing device 601 is sent to the computing device. Computing device 603 decodes the encoded data, such as in step 507 from FIG. 5. One or more of associated reader computing device 601, computing device 603, and/or server 605 coupled to a network bus 607 then utilizes the decoded encoded data to determine how information on the hardcopy printout or copy thereof that included the encoded data was disseminated. With respect to each of these components 601, 603, and 605, one or more software modules resident on one or more of the components may be configured to perform one or more of the operations of receiving reading encoded data, decoding the encoded data, and determining how to use the decoded encoded information.

FIG. 7 is an illustrative diagram of a comparison between a hardcopy printout and a read hard copy printout in accordance with at least one aspect of the present invention. FIG. 7 illustrates an example of an associated reader computing device being preconfigured properly to read encoded data from a hardcopy printout. A printer 701 is shown to make a hardcopy printout 703. In this example, the hardcopy printout 703 included confidential information that should not be removed from an office. In this example, hardcopy printout 703 is shown to include five glyphs of encoded data 705_1 through 705_5 configured on the hardcopy printout 703. In this example, glyph 705_1 is a starting position glyph. Glyph 705_1 may include an identifier representative of the starting position for reading the encoded data. In an alternative embodiment, other encoded data on the hardcopy printout 703 may include an identifier of the starting position for reading the encoded data from the hardcopy printout.

As should be understood by those skilled in the art, many starting point techniques may be utilized in accordance with one or more aspects of the present invention. In accordance with at least one example, a mathematical method of page analysis may be utilized to produce a consistent starting position for reading encoded data from the page. For example, one technique may be for an associated reader computing device to analyze a page for a percentage of black pixels across an overlaid grid. When a page is captured as a black and white image, there is a total pixel count that may be proportioned out to white and black pixels. This also may be computed for a quadrant on the document page. Regardless of the resolution, the proportions would be relatively consistent, provided the document was not altered. The calculation may need to include enough tolerance in the proportion value to account for variation in capture devices and paper marking.

Another illustrative technique may be to analyze the page for corner proximity to the nearest non-white pixel. In such a technique, the distance from each corner to the nearest non-white pixel may be used as numerical values entered into a predetermined algorithm to locate the starting position. Still another illustrative technique may be to analyze the page to measure the longest diagonals of non-white pixels in two dimensions and then to compare the lengths of the two diagonals. In such a technique, the document page is scanned at a 45-degree and a 135-degree angle rather than 90-degree left-right and up-down. Such a technique may produce more skew-resistant results. Such proportions may be utilized to make an algorithm more resilient against magnification and reduction. Because these are proportional measures (ratio of one diagonal to another), they are resistant to errors induced by magnification and reduction as long as the aspect ratio is maintained. 8:5 is the same as 16:10, for example.

From starting position glyph 705_1, data may be encoded within the glyph 705_1 to indicate that glyph 705_2 includes the next encoded data to be read. Similarly, from glyph 705_2 to glyph 705_3, glyph 705_3 to glyph 705_4, and glyph 705_4 to glyph 705_5, data may be encoded within glyphs 705_2, 705_3, and 705_4, respectively, to indicate that glyphs 705_3, 705_4, and 705_5, respectively, includes the next encoded data to be read. In this example, glyph 705_5 may include data as an identifier that glyph 705_5 is the last glyph to be read. With respect to the hardcopy printout 703, a pattern of paths 707_1 to 707_5 is created.

The pattern may be preconfigured within an associated reader computing device 709 so that the associated reader computing device 709 knows the starting position glyph 705_1 to read from the hardcopy printout. As such, the associated reader computing device 709 is configured to read the hardcopy printout 703 from the starting position glyph 705_1. In an alternative embodiment, the associated reader computing device 709 may read the hardcopy printout 703 until it determines the starting position glyph to begin reading the encoded data. For example, associated reader computing device 709 may be configured to start reading from the upper left corner of a hardcopy printout until the starting position glyph is determined.

As shown in FIG. 7, associated reader computing device 709 reads the hardcopy printout 703, such as to scan the document. A broken line representation 711 of the hardcopy printout 703 is shown. In reading the hardcopy printout 703 and in knowing the staring position glyph 705_1, whether by a preconfigured condition and/or by determination itself, the associated reader computing device 709 reads the encoded data glyphs 705_1 to 705_5 from the hardcopy printout 703 in the same pattern 713. As such, all the encoded data, in a proper order, may be read and determined by the associated reader computing device.

Although shown to include only five glyphs 705_1 to 705_5 to make up the pattern 707_1 to 707_5, it should be understood by those skilled in the art that additional or fewer glyphs may be utilized and/or noise representations may be included. In addition, it should be understood that the pattern may be configured to include a particular glyph or noise more than once. The use of such multiple identical glyphs may be used to duplicate the payload of data to improve survivability. In addition, although not shown in FIG. 7, random dispersion may vary over time to further maintain the appearance of random noise, while adhering to the use of multiple pre-set anchor points as seeds for the search illustrated in FIG. 7.

In accordance with at least one other aspect of the present invention, data may be encoded onto a document page based upon the characters and/or ink location of content to be printed onto the document page. For example, software associated with a computer, printer, and/or device in between, such as a printer server, may be configured to determine where encoded data is placed on a printed page by where content for that document page will be printed. If content is queued to print on a document page in a word processing type application, such as Word by Microsoft® Corporation of Redmond, Wash., the content may be configured to print with a set margin in place. In one example, a margin of 1 inch around the entire document page may be configured. In such an example, data may be encoded in the margin alone, within the content alone, and/or within both. In addition, the data may be encoded based upon any of a number of parameters. For example, the data may be encoded in the content based upon some parameter, such as the third occurrence of the word “the.” In such an example, the third “the” in the document page are encoded with data. In another example, data may be encoded within a first occurrence of a doubled letter, such as the “t”s in the word “letter.” Still another example includes encoding data in the underlined portion of an underlined word, or in italicized or bolded words. Any of these examples may be a starting position for reading the encoded data. These are but a few examples in accordance with one or more aspects of the present invention and any of a number of different parameters may be utilized and the present invention should not be limited to the examples provided herein.

In still other configurations, it should be understood that the encoded data may be printed to and read from PDF document files as well. As such, even if an individual requests a print job to an Adobe PDF, data still may be encoded onto the rendered PDF document file. Therefore, even if the PDF is then printed at an external printer, the encoded data glyph, noise, combination, and/or pattern is still included within any hardcopy printout of the PDF document file.

In addition, it should be understood by those skilled in the art that one or more aspects of the present invention may be utilized within one or a plurality of computing devices.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method for securing and tracing data comprising:
receiving a request to generate a hardcopy printout;
generating document output instructions for the request;
determining data to associate with the document output instructions;
encoding the data with the generated document output instructions; and
outputting the hardcopy printout with the encoded data,
wherein the encoded data appears as at least three representations of noise on the hardcopy printout,
wherein the encoded data includes information specific to a terminal device associated with the request,
wherein the encoded data includes an identifier representative of a starting position for reading the encoded data.

2. The method of claim 1, wherein receiving and generating occur at a computer and encoding and outputting occurs at a printer.

3. The method of claim 1, wherein one or more software modules perform the encoding.

4. The method of claim 1, wherein the data to associate with the document output instructions includes session specific data.

5. The method of claim 1, wherein the data to associate with the document output instructions includes document specific data.

6. The method of claim 1, wherein the data to associate with the document output instructions includes user specific data.

7. The method of claim 1, wherein the encoded data is configured to be read by an associated reader computing device configured to read the encoded data from the stating position.

8. The method of claim 7, wherein the associated reader computing device is configured to read the encoded data in accordance with a known pattern of noise.

9. The method of claim 8, wherein the known pattern of noise is based upon the location of the starting position.

10. The method of claim 8, wherein the known pattern of noise is based upon a previous configuration of the associated reader computing device.

11. The method of claim 7, wherein the starting position is determined based upon a percentage of black pixels.

12. The method of claim 7, wherein the starting position is determined based upon a distance from each corner of the hard copy printout to a nearest non-white pixel.

13. The method of claim 7, wherein the starting position is determined based upon a comparison of lengths of two longest diagonals of non-white pixels on the hardcopy printout.

14. The method of claim 1, wherein the step of determining includes:
identifying an individual associated with the request; and
identifying the data to associate based upon the identified individual.

15. The method of claim 1, wherein the outputting comprises generating a PDF file including data of the hardcopy printout with the encoded data.

16. A system for securing and tracing data comprising at least one computing component configured to:
receive a request to generate a hardcopy printout;
generate document output instructions for the request;
determine data to associate with the document output instructions;
encode the data with the generated document output instructions; and
output the hardcopy printout with the encoded data,
wherein the encoded data appears as at least three representations of noise on the hardcopy printout,
wherein the encoded data includes information specific to a terminal device associated with the request,
wherein the encoded data includes an identifier representative of a starting position for reading the encoded data.

17. The system of claim 16, wherein the at least one computing component includes a computer and a printer.

18. The system of claim 17, wherein the printer is configured to encode the data and to output the hardcopy printout.

19. The system of claim 16, wherein the encoded data is configured to be read from a photocopy made of the hardcopy printout with the encoded data.

20. The system of claim 16, wherein the at least one computing device includes a computer and server, wherein the server is configured to encode the data and is further configured to send a command to a printer, connected to the server.

21. One or more computer-readable media storing computer-executable instructions which, when executed by a processor on a computer system, perform a method for encoding data, the method comprising:
receiving document output instructions corresponding to a request to generate a hardcopy printout;
determining data to associate with the document output instructions;
encoding the data with the generated document output instructions; and,
wherein the encoded data appears as at least three representations of noise on the hardcopy printout,
wherein the encoded data includes information specific to a terminal device associated with the request,
wherein the encoded data includes an identifier representative of a starting position for reading the encoded data.
